(19) United States
(12) Patent Application Publication
(10) Pub. No.: US 2026/0356403 A1
(43) Pub. Date: Nov. 12, 2026

(54) CONTROLLER, TRAVELING VEHICLE SYSTEM, AND CANCELLATION METHOD

(71) Applicant: MURATA MACHINERY, LTD, Kyoto-shi, Kyoto (JP)

(72) Inventor: Wataru Kitamura, Inuyama-shi, Aichi (JP)

(73) Assignee: MURATA MACHINERY, LTD, Kyoto-shi, Kyoto (JP)

(21) Appl. No.: 19/124,730

(22) PCT Filed: Oct. 5, 2023
(86) PCT No.: PCT/JP2023/036328

§ 371 Date: Apr. 25, 2025

(30) Foreign Application Priority Data
Oct. 27, 2022 (JP) 2022-172265

(51) Int. Cl. B61L 27/10; B61B 3/02; B61C 13/04; B61L 27/53

(52) U.S. Cl. CPC B61L 27/10; B61B 3/02; B61C 13/04; B61L 27/53

(57) ABSTRACT

To prevent a user from inadvertently canceling a passage-prohibited area that should be canceled.

A controller 5 that controls traveling of a traveling vehicle 3 on a track 2 includes a passage prohibition setter 30 that sets a predetermined area on the track 2 as a passage-prohibited area, and a passage prohibition canceler 31 that executes, where a first user performs a cancellation operation for the passage-prohibited area, specific processing including a process of confirming whether a second user, different from the first user, has approved cancellation of the passage-prohibited area. The passage prohibition canceler 31 cancels the passage-prohibited area where it is confirmed that the second user has approved cancellation of the passage-prohibited area.

### CROSS REFERENCE TO RELATED APPLICATIONS

This application is a US national stage filing under 35 U.S.C. § 371 of International Application No. PCT/JP2023/036328 filed Oct. 5, 2023, which claims priority to Japanese Patent Application No. 2022-172265, filed Oct. 27, 2022, each of which is incorporated herein by reference in its entirety.

### TECHNICAL FIELD

This disclosure relates to a controller, traveling vehicle system, and a cancellation method.

### BACKGROUND

Japanese Patent No. 6,589,820 discloses a passage regulator that regulates the passage of overhead transport vehicles traveling along a track. This passage regulator uses a mechanical stopper to temporarily prohibit passage through a region where maintenance work is conducted when a worker conducts maintenance work on the track. This ensures the safety of the worker conducting maintenance work.

In the above method, a user (for example, a worker) prohibits passage through a passage-prohibited area by installing a mechanical stopper to prohibit the passage of overhead transport vehicles. However, in addition to mechanical stoppers, software-based methods to prohibit the passage of overhead transport vehicles may also be considered. For example, the user sets a passage-prohibited area on a controller that controls the traveling of the overhead transport vehicles. The controller can temporarily prohibit passage through the passage-prohibited area by controlling the traveling of the overhead transport vehicles to prevent the overhead transport vehicles from traveling through the set passage-prohibited area.

When the user intends to cancel a passage-prohibited area that has been set by a software-based method, the user must perform a cancellation operation for the passage-prohibited area on the controller. During this process, the user may inadvertently perform an operation to cancel a passage-prohibited area that should not be canceled. It is therefore desirable to prevent such erroneous operations.

It could therefore be helpful to prevent a user from inadvertently canceling a passage-prohibited area that should be canceled.

### SUMMARY

A controller controls traveling of a traveling vehicle on a track. The controller includes a passage prohibition setter that sets a predetermined area on the track as a passage-prohibited area, and a passage prohibition canceler that executes, where a first user performs a cancellation operation for the passage-prohibited area, specific processing including a process of confirming whether a second user, different from the first user, has approved cancellation of the passage-prohibited area, wherein the passage prohibition canceler cancels the passage-prohibited area where the second user has approved cancellation of the passage-prohibited area.

A traveling vehicle system includes a traveling vehicle, a track on which the traveling vehicle travels, and a controller that controls the traveling vehicle that travels along the track. The controller includes a passage prohibition setter that sets a predetermined area on the track as a passage-prohibited area, and a passage prohibition canceler that executes, where a first user performs a cancellation operation for the passage-prohibited area, specific processing including a process of confirming whether a second user, different from the first user, has approved cancellation of the passage-prohibited area, wherein the passage prohibition canceler cancels the passage-prohibited area where it is confirmed that the second user has approved cancellation of the passage-prohibited area.

A cancellation method is a cancellation method for canceling a passage-prohibited area in a predetermined area on a track on which a traveling vehicle travels, the method comprising executing, where a first user performs a cancellation operation for the passage-prohibited area, specific processing including a process of confirming whether a second user, different from the first user, has approved cancellation of the passage-prohibited area, and canceling the passage-prohibited area where it is confirmed that the second user has approved cancellation of the passage-prohibited area.

According to the controller, the traveling vehicle system, and the cancellation method of the above aspect, the approval from the second user, different from the first user who performed the cancellation operation, is required when canceling a passage-prohibited area, and it is thus possible to prevent a user from inadvertently canceling a passage-prohibited area that should be canceled.

In the controller of the above aspect, the passage prohibition setter may set the predetermined area as the passage-prohibited area on condition that the second user has approved the setting of the passage-prohibited area, where the first user performs the setting operation. When the first user performs the setting operation for the passage-prohibited area, the passage prohibition setter may confirm whether the second user, different from the first user, has approved setting of the passage-prohibited area. According to such a configuration, when the first user performs the setting operation, the approval of the second user is required, and it is therefore possible to prevent the first user from inadvertently setting an area that should not be set as a passage-prohibited area.

In the controller of the above aspect, in setting the predetermined area as the passage-prohibited area, the passage prohibition setter may display on a display an input screen having an input field to input a reason for setting the passage-prohibited area, and store in a memory storage information input into the input field and information indicating the passage-prohibited area in association with each other. According to such a configuration, when canceling the passage-prohibited area, the first user can grasp the reason for setting the passage-prohibited area, thereby suppressing operational mistakes during the cancellation operation.

In the controller of the above aspect, the specific processing may include a first confirmation process in which, where the cancellation operation is performed, the first user's intent to cancel the passage prohibition is confirmed by displaying on a display either or both of identification information of the second user who performed the setting operation for the passage-prohibited area and a setting reason for the passage prohibition, and a second confirmation process in which, where the first user's cancellation intent is confirmed in the first confirmation process, whether the second user has approved the cancellation of the passage prohibition is confirmed. According to such a configuration, the first user can confirm on the display screen of the display the reason for setting the passage-prohibited area that is to be canceled, thereby suppressing operational mistakes during the cancellation operation.

In the controller of the above aspect, the passage prohibition canceler may, as the second confirmation process, display on the display a confirmation screen to confirm whether the second user has approved the cancellation of the passage-prohibited area, and cancel the passage-prohibited area where a predetermined operation is performed on the confirmation screen. According to such a configuration, the first user receives two alerts, and it is thus possible to suppress operational mistakes during the cancellation operation.

In the controller of the above aspect, the passage prohibition canceler may, as the second confirmation process, transmit to an information terminal used by the second user a request to the second user to approve cancellation of the passage prohibition, and cancel the passage-prohibited area where information indicating approval is received from the information terminal. According to such a configuration, when canceling a passage-prohibited area, an operation for approval performed by the second user is required on the information terminal, and it is thus possible to suppress operational mistakes during the cancellation operation.

In the controller of the above aspect, the passage-prohibited area can be set to either a first level or a second level, and the passage prohibition canceler may execute the specific processing when canceling the passage-prohibited area set to the second level and may, without executing the specific processing, cancel the passage prohibition of the predetermined area set to the first level based on the cancellation operation by the first user when canceling the passage-prohibited area set to the first level. According to such a configuration, the approval of the second user is required only for canceling a second-level passage-prohibited area that requires monitoring for setting cancellation, and this contributes to enhancing the efficiency of the process related to cancellation of a passage-prohibited area.

In the controller of the above aspect may include a notifier that notifies all users, including the first user and the second user registered in the controller, where the passage-prohibited area is canceled. According to such a configuration, information about the cancellation of a passage-prohibited area can be shared with all users, thereby improving the safety of the passage-regulated area. When the first user performs the setting operation for the passage-prohibited area, the passage prohibition setter may confirm whether a second user, different from the first user, has approved the setting of the passage-prohibited area, and set the passage-prohibited area where it is confirmed that the second user has approved the setting of the passage-prohibited area.

### BRIEF DESCRIPTION OF THE DRAWINGS

FIG. 1 is a schematic configuration diagram of a traveling vehicle system.

FIG. 2 is a diagram showing an example of tracks.

FIG. 3 is a diagram showing an example of a hardware configuration of a controller.

FIG. 4 is a functional block diagram of a processor.

FIG. 5 is a diagram showing an example of a management screen.

FIG. 6 is a diagram showing an example of an input screen.

FIG. 7 is a diagram showing an example of a first confirmation screen.

FIG. 8 is a diagram showing an example of a second confirmation screen.

FIG. 9 is a diagram showing an example of a message screen.

FIG. 10 is a flowchart showing an example of a cancellation process.

FIG. 11 is a flowchart of the cancellation process in performing an approval request.

### DESCRIPTION OF REFERENCE SIGNS

G: Grid cell
1: Traveling vehicle system
2: Track
3: Traveling vehicle
4: Administrator's terminal
5: Controller
30: Passage prohibition setter
31: Passage prohibition canceler
32: Notifier

### DETAILED DESCRIPTION

Hereinafter, my controller, system and method will be described through an example. However, this disclosure as defined in the claims is not limited to the following example, and not all combinations of features described in the example are essential. In the drawings, the same or similar members are denoted by the same reference signs, and redundant descriptions may be omitted. The shape and size of the elements in the drawings may be exaggerated for the purpose of clearer description.

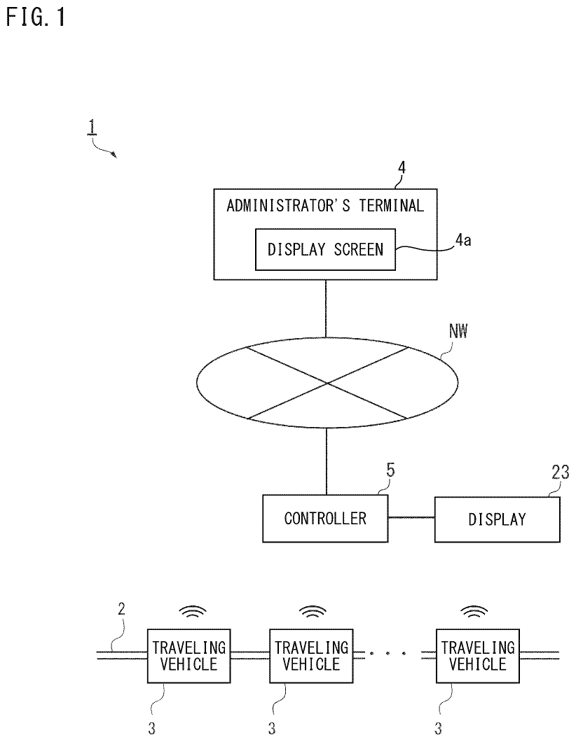

FIG. 1 is a schematic configuration diagram of a traveling vehicle system 1. A traveling vehicle system 1 controls traveling vehicles 3 that travel along tracks 2. The traveling vehicle system 1 controls the traveling of the traveling vehicles 3 to ensure, where there is an area on the tracks 2 that is set as passage-prohibited (hereinafter referred to as “passage-prohibited area”), the traveling vehicles 3 do not pass through the passage-prohibited area.

A first user can set a passage-prohibited area by inputting information on the passage-prohibited area into a controller 5 of the traveling vehicle system 1. In canceling a passage-prohibited area, the first user can cancel the passage-prohibited area by performing an operation to cancel the passage-prohibited area (hereinafter referred to as “cancellation operation”) on the controller 5 of the traveling vehicle system 1. The first user is, for example, an operator. When canceling a passage-prohibited area by a cancellation operation performed by the first user, the traveling vehicle system 1 cancels the passage-prohibited area on condition that a second user, different from the first user, has approved the cancellation. A configuration of the traveling vehicle system 1 will be described below. The second user is, for example, an operator administrator. The operator administrator is the individual responsible for coordinating the operators.

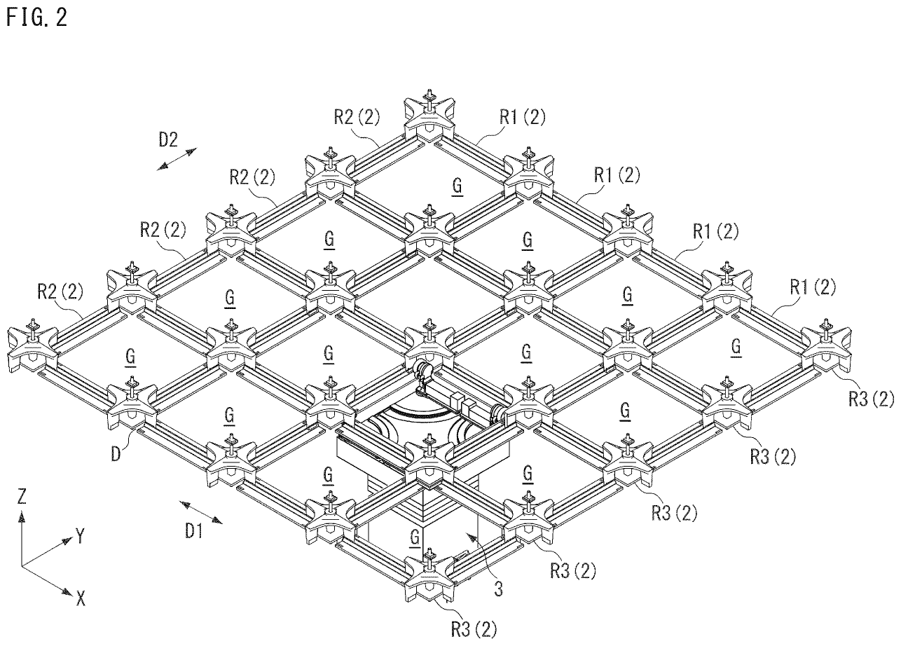

As shown in FIG. 1, the traveling vehicle system 1 includes tracks 2, multiple traveling vehicles 3, an administrator's terminal 4, and the controller 5. The tracks 2 are routes along which the traveling vehicle 3 can travel. FIG. 2 is a diagram showing an example of the tracks 2. For example, the tracks 2 are grid-patterned tracks. In other words, the tracks 2 are grid-patterned tracks that are arranged to form a grid shape in plan view. The grid-patterned tracks is an example of the tracks 2. The tracks 2 are installed, for example, on or in the vicinity of the ceiling of a building such as a clean room.

The tracks 2 include first tracks R1, second tracks R2, and partial tracks R3. The first tracks R1 are provided along the X direction (first direction). The second tracks R2 are provided along the Y direction (second direction). A plurality of the first tracks R1 and a plurality of the second tracks R2 are provided along directions orthogonal to each other but not intersecting directly with each other. The partial track R3 is arranged at each intersecting portion where the first track R1 and the second track R2 intersect with each other.

The tracks 2 are provided along directions in which the first track R1 and the second track R2 are orthogonal to each other. The tracks 2 are configured with grid-patterned cells (“grid cells”) G, arranged adjacent to one another in plan view. The traveling vehicle 3 is formed in a size that fits in a single grid cell G as seen in plan view. This configuration enables one traveling vehicle 3 to pass another traveling vehicle 3 traveling on an adjacent track 2, and when multiple traveling vehicles 3 are arranged on the tracks 2, it increases the range in which each traveling vehicle 3 can travel without interfering with other traveling vehicles 3.

The first tracks R1, the second tracks R2, and the partial tracks R3 are suspended from the ceiling by suspenders (not shown in the drawings). The first tracks R1, the second tracks R2, and the partial tracks R3 are provided along the same or substantially the same horizontal plane (XY plane).

The traveling vehicle 3 travels along a track 2. For example, the traveling vehicle 3 is a transport vehicle that transports articles (for example, overhead transport vehicle). As an example, the traveling vehicle 3 transports articles, such as semiconductor wafers, in the clean room of a semiconductor manufacturing factory, for example. The article is, for example, a Front-Opening Unified Pod (FOUP) or a reticle pod that accommodates reticles. The traveling vehicle system 1 is also applicable to facilities in fields other than semiconductor device manufacturing.

Each traveling vehicle 3 is connected to the controller 5 via a communication network NW to transmit and receive information to and from the controller 5. The communication network NW may be a transmission path for wireless communication, or may be a combination of a transmission path for wireless communication and a transmission path for wired communication. For example, the communication network NW may be a mobile communication network such as a cellular network, a wireless packet communication network, a short-range wireless communication standard such as ZigBee (registered trademark), Wi-Fi (registered trademark), BLE, or a combination of these.

The administrator's terminal 4 is a terminal used by the second user, and is connected to the controller 5 through the communication network NW. The administrator's terminal 4 has a display screen 4a for displaying information. The administrator's terminal 4 transmits and receives information to and from the controller 5 through the communication network NW. For example, the administrator's terminal 4 displays on the display screen 4a information transmitted to and received from the controller 5 through the communication network NW. For example, the administrator's terminal 4 is a computer. However, our method is not limited to this example, and the administrator's terminal 4 may be a wearable terminal or a portable information terminal. Examples of the portable information terminal include a smartphone and a tablet terminal.

The operator administrator uses the administrator's terminal 4 to approve cancellation of a passage-prohibited area. For example, when an approval request is received from the controller 5, the administrator's terminal 4 presents a notification of the approval request on the display screen 4a. The operator administrator confirms the contents of the approval request, and if approving the approval request, performs an operation of approving the approval request on the administrator's terminal 4. When the operation of approving the approval request is performed, the administrator's terminal 4 transmits an approval notification to the controller 5. If denying the approval request, the operator administrator performs an operation of denying the approval request on the administrator's terminal 4. When the operation of denying the approval request is performed, the administrator's terminal 4 transmits an approval denial notification to the controller 5.

The controller 5 wirelessly communicates with the multiple traveling vehicles 3 and controls the traveling of the traveling vehicles 3 on the tracks 2. The controller 5 selects a traveling route for each traveling vehicle 3 so as to avoid passage-prohibited areas and causes the traveling vehicles 3 to travel along the selected traveling route. The controller 5 also has a function of setting and canceling a passage-prohibited area.

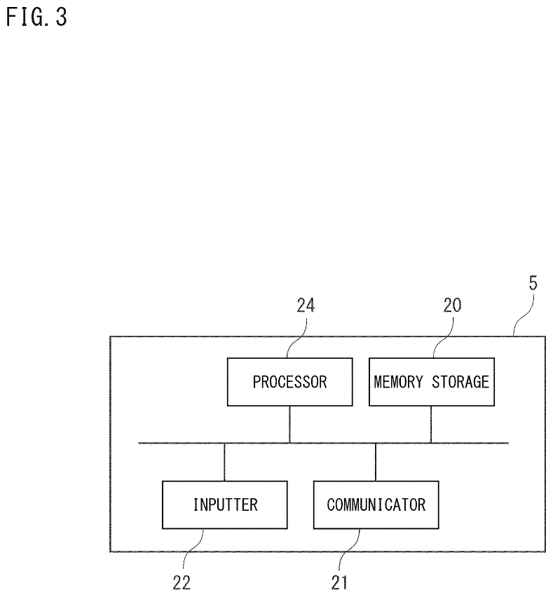

FIG. 3 is a diagram showing an example of a hardware configuration of the controller 5. As shown in FIG. 3, the controller 5 includes a memory storage 20, a communicator 21, an inputter 22, and a processor 24. The controller 5 is connected to a display 23. The display 23 displays various information. For example, the display 23 is a monitor for a personal computer. However, the display 23 is not limited to this example and may be a display device (display) of a portable device such as a mobile phone, smartphone, and tablet terminal. The controller 5 may include the display 23. The memory storage 20 may be an external memory storage, rather than being part of the configuration of the controller 5. When the memory storage 20 is an external memory storage, the controller 5 is connected to the memory storage 20 via wired or wireless communication and transmits and receives information to and from the memory storage 20.

The memory storage 20 stores, for example, a program (software) for executing the setting and cancellation of passage-prohibited areas, along with data processed by this program. The memory storage 20 also stores information required for the setting and cancellation of passage-prohibited areas.

Examples of the memory storage 20 include non-volatile memory, such as ROM (Read Only Memory), HDD (Hard Disk Drive), and SSD (Solid State Drive). The program mentioned above may be provided by a computer-readable storage medium, or may be provided from an external device via the communication network NW. The provided program is stored in the memory storage 20 and executed by the processor 24.

The communicator 21 is a communication interface for communicating with external devices. The communicator 21 communicates with the traveling vehicles 3 via the communication network NW. The communicator 21 communicates with the administrator's terminal 4 via the communication network NW. The communicator 21 is capable of communicating with communication terminals other than the traveling vehicles 3 and the administrator's terminal 4 via the communication network NW.

The inputter 22 accepts input operations from a user. For example, when the inputter 22 receives an input operation from a user, the inputter 22 transmits information corresponding to the received input operation to the processor 24 or the memory storage 20. Examples of the inputter 22 include pointing devices such as a touch panel, touchpad, or mouse, buttons, switches, motion-sensitive controllers, keyboards, mice, gesture input devices, and voice input devices (for example, a microphone).

The processor 24 executes processes related to the setting and cancellation of passage-prohibited areas. The processor 24 creates a traveling route that avoids the passage-prohibited areas and controls the traveling of the traveling vehicle 3 based on the traveling route so as to avoid the passage-prohibited areas. The processor 24 executes the program stored in the memory storage 20 and is capable of performing operations described by the program, that is, the processes related to the setting and cancellation of passage-prohibited areas. As an example, the processor 24 includes at least one of a CPU (Central Processing Unit), MPU (Microprocessing Unit), or GPU (Graphics Processing Unit).

The above program may be provided on a computer-readable storage medium. The program is read from a computer-readable storage medium, installed in the memory storage 20, and then executed by the processor 24. The above program may be downloaded from an external device through the communication network NW.

Examples of the computer-readable storage medium may include electronic storage media, magnetic storage media, optical storage media, electromagnetic storage media, and semiconductor storage media. More specific examples of the computer-readable storage medium may include diskettes, hard disks, random access memories (RAM), read-only memories (ROM), erasable programmable read-only memories (EPROM or flash memory), electrically erasable programmable read-only memories (EEPROM), static random access memories (SRAM), compact disc read-only memories (CD-ROM), digital versatile discs (DVD), Blu-ray (RTM) discs, memory sticks, and integrated circuit cards.

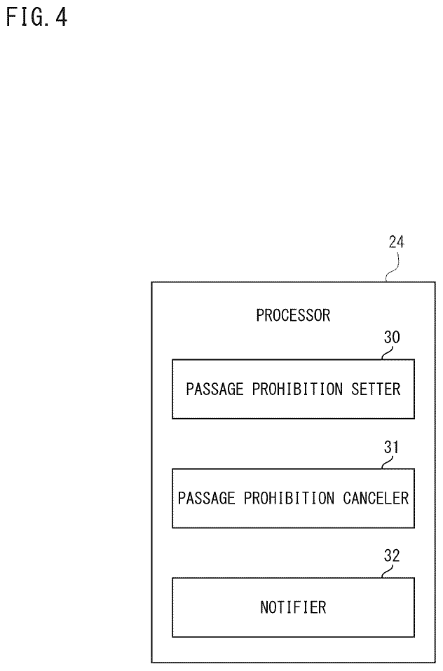

The functional units of the processor 24 will be described, with reference to FIG. 4. FIG. 4 is a functional block diagram of the processor 24. As shown in FIG. 4, the processor 24 includes a passage prohibition setter 30, a passage prohibition canceler 31, and a notifier 32. The passage prohibition setter 30, the passage prohibition canceler 31, and the notifier 32 are implemented by the processor 24 executing the above program stored in the memory storage 20.

The display 23 displays a management screen CP. The management screen CP is a screen that allows, for example, checking the traveling state of the traveling vehicles 3 on tracks 2, issuing traveling instructions to the traveling vehicles 3, setting passage-prohibited areas, and canceling passage-prohibited areas. When the user logs into the system of the controller 5 through user authentication, the processor 24 displays the management screen CP on the display 23. This user authentication is a mechanism where the user inputs authentication information, included in the user information preliminarily registered in the memory storage 20, into the controller 5 using an IC card or the inputter 22, thus enabling the use of the controller 5. The authentication information is information required for user authentication, such as an email address, a user ID, and a password. In addition to the authentication information, the memory storage 20 stores user information, such as name and authorization information, for each user. The authorization information is, for example, information indicating whether the user is an operator or an operator administrator.

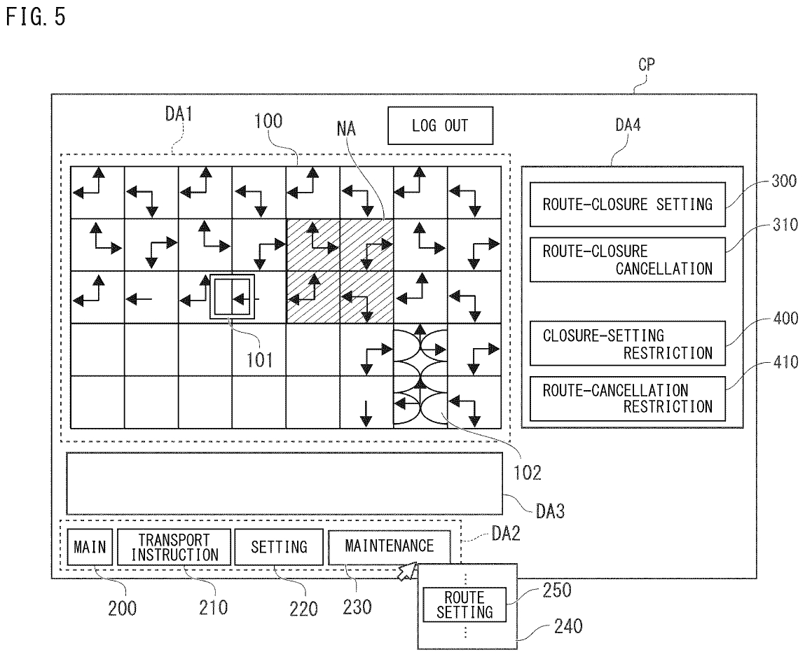

FIG. 5 is a diagram showing an example of the management screen CP. The management screen CP includes, for example, a first display region DA1, a second display region DA2, a third display region DA3, and a fourth display region DA4.

In the first display region DA1, a track screen 100 simulating the entire tracks 2 in a plan view is displayed. On this track screen 100, the current location of a traveling vehicle 3 is displayed by a traveling vehicle icon 101. The traveling vehicle icon 101 moves in accordance with the traveling of the actual traveling vehicle 3. On the track screen 100, the locations of container storages that store articles are displayed by storage icons 102. The container storages, for example, allow container transfer from a transport vehicle that transports containers and are arranged in the vicinity of the ceiling. When a passage-prohibited area is set, a passage-prohibited area NA is displayed on the track screen 100 (the shaded region in FIG. 5). For example, the passage-prohibited area NA displayed on the track screen 100 is displayed in a manner that distinguishes it from other areas. For example, the passage-prohibited area NA is displayed in a color different from other areas.

In the second display region DA2, a main button 200, a transport instruction button 210, a setting button 220, and a maintenance button 230 are displayed.

When the user operates the main button 200, the processor 24 causes the management screen CP to display the main screen. When the user operates the main button 200, the processor 24 causes the display 23 to display the main screen. “Operation” refers to an operation performed through the inputter 22, such as a keyboard, a mouse, or a touch panel. This operation may include actions such as touching the display screen of display 23 or operating keyboard icons for character input or the like displayed on the display screen of the display 23.

When the user operates the transport instruction button 210, the processor 24 causes the display 23 to display a transport instruction screen for transmitting a transport instruction to the traveling vehicle 3. On the transport instruction screen, a traveling vehicle 3 and its destination can be specified, and route information to the destination can be registered. This route information is transmitted to the instruction target traveling vehicle 3 as a transport instruction. When the user operates the setting button 220, the processor 24 causes the display 23 to display a setting screen for making various settings of the traveling vehicle system 1.

When the maintenance button 230 is operated, the processor 24 causes the display 23 to display a maintenance menu screen 240 on the display screen of the display 23. On the maintenance menu screen 240, multiple buttons corresponding to various maintenance processes in the traveling vehicle system 1 are displayed. These multiple buttons include a route setting button 250, and when this route setting button 250 is operated by the user, it allows the selection of a predetermined area on the tracks 2 (hereinafter referred to as “specific area”) on the management screen CP (for example, the track screen 100). A specific area refers to one or more grid cells G. The processor 24 manages the state of each grid cell G on the tracks 2. The state of a grid cell G refers to whether the grid cell G is in either a passage-prohibited state or a passage-permitted state. As an example, the memory storage 20 stores information identifying the grid cell G and information indicating the state of the grid cell G, with the two being associated. In other words, the state of each grid cell G is stored in the memory storage 20. The processor 24 manages the state information of each grid cell G stored in the memory storage 20. When the route setting button 250 is operated, the processor 24 reads the state of each grid cell G from the memory storage 20 and displays the state of each grid cell G of the tracks 2 on the track screen 100.

When the route setting button 250 is operated, information on the currently set passage-prohibited area is displayed in the third display region DA3. For example, in the third display region DA3, information on the grid cells G that are set as a passage-prohibited area is displayed for each passage-prohibited area. In the state where the route setting button 250 is not being operated, route information of each traveling vehicle 3 may be displayed in the third display region DA3.

In the fourth display region DA4, a route-closure setting button 300, a route-closure cancellation button 310, a closure-setting restriction button 400, and a closure-cancellation restriction button 410 are displayed. For example, when the route setting button 250 is operated, in the fourth display region DA4, the route-closure setting button 300, the route-closure cancellation button 310, the closure-setting restriction button 400, and the closure-cancellation restriction button 410 are displayed.

The route-closure setting button 300 is operated when a specific area (for example, one or more grid cells G) selected by the user is set as a passage-prohibited area. The route-closure cancellation button 310 is operated when canceling a passage-prohibited area selected by the user.

The closure-setting restriction button 400 and the closure-cancellation restriction button 410 are buttons that can be operated only by the operator administrator among the users. The closure-setting restriction button 400 is operated by the operator administrator when restricting the setting of a passage-prohibited area. The closure-cancellation restriction button 410 is operated by the operator administrator when restricting the cancellation of a passage-prohibited area. “Restriction” means that approval of the operator administrator is required. In other words, operating the closure-setting restriction button 400 results in requiring the approval of the operator administrator when setting a passage-prohibited area. Operating the closure-cancellation restriction button 410 results in requiring the approval of the operator administrator when canceling a passage-prohibited area. Whether the user pressing the closure-setting restriction button 400 or the closure-cancellation restriction button 410 is an operator or an operator administrator may be identified based on the authorization information. For example, the passage prohibition setter 30 may identify whether the user pressing the closure-setting restriction button 400 or the closure-cancellation restriction button 410 is an operator or an operator administrator, based on the authorization information of the logged-in user.

The passage prohibition setter 30 sets a passage prohibition for a predetermined area on the tracks 2. For example, if information is acquired indicating that a setting operation has been performed to instruct the setting of a passage prohibition for a specific area consisting of one or more grid cells G, the passage prohibition setter 30 detects the setting operation and sets the specific area as a passage-prohibited area. The setting operation here refers, for example, to a pressing operation performed on the route-closure setting button 300.

When the route-closure setting button 300 is operated (for example, pressed) with a specific area being selected by the user, the passage prohibition setter 30 sets the specific area as a passage-prohibited area. For example, when the route-closure setting button 300 is operated, with a specific area being selected, the passage prohibition setter 30 sets the state of the grid cells G of the specific area stored in the memory storage 20 to a passage-prohibited area. If there is no restriction on setting a passage-prohibited area, the passage prohibition setter 30 sets the selected specific area as a passage-prohibited area when the route-closure setting button 300 is operated, regardless of whether or not the operator administrator has granted approval. If there is a restriction on setting a passage-prohibited area, when the route-closure setting button 300 is operated, with a specific area being selected, the passage prohibition setter 30 sets the specific area as a passage-prohibited area, on condition that the operator administrator has granted approval. For example, if there is a restriction on setting a passage-prohibited area, when the route-closure setting button 300 is operated, with a specific area being selected, the passage prohibition setter 30 transmits an approval request to the administrator's terminal 4 and sets the specific area as a passage-prohibited area if the operator administrator has approved the approval request.

The passage prohibition setter 30 can set either a first level or a second level for a passage-prohibited area. The cancellation process differs between a first-level passage-prohibited area and a second-level passage-prohibited area. When a first-level passage-prohibited area is to be canceled, no approval of the operator administrator is required. On the other hand, if a second-level passage-prohibited area is to be canceled, the approval of the operator administrator is required. For example, when the route-closure setting button 300 is operated, the passage prohibition setter 30 sets the passage-prohibited area to the first level. After setting the passage-prohibited area, the passage prohibition setter 30 can change the passage-prohibited area from the first level to the second level. For example, when the closure-cancellation restriction button 410 is operated by the operator administrator, with a passage-prohibited area being selected by the operator administrator, the passage prohibition setter 30 sets the level of the passage-prohibited area to the second level. The setting of a passage-prohibited area performed by the passage prohibition setter 30 may be referred to as a setting process.

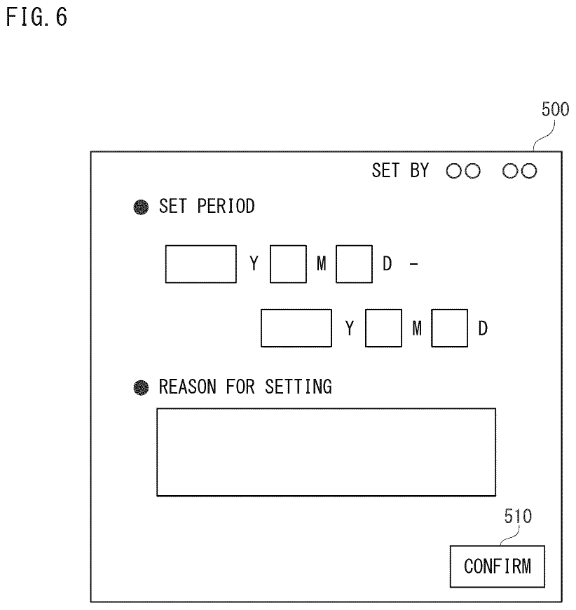

A specific example of the setting process will be described below. When the route-closure setting button 300 is pressed, an input screen 500 is displayed on the display screen of the display 23. FIG. 6 is a diagram showing an example of the input screen 500. Multiple input fields for inputting a set period and a setting reason are provided on the input screen 500. The set period refers to the period during which a specific area is to be set as passage-prohibited. The setting reason refers to the reason for setting a specific area as a passage-prohibited area.

The user operates the inputter 22 to input a set period and a setting reason on the input screen 500 and presses a confirmation button 510 on the input screen 500. When the confirmation button 510 is pressed, the passage prohibition setter 30 sets the specific area as a passage-prohibited area. For example, the passage prohibition setter 30 stores in the memory storage 20 information input in the input fields on the input screen 500 in association with information indicating a passage-prohibited area. The information indicating a passage-prohibited area is information identifying the passage-prohibited area and may include the identification information and location information of the passage-prohibited area. As a specific example, upon depression of the confirmation button 510 on the input screen 500, the passage prohibition setter 30 associates and stores, in the memory storage 20, the identification information of the set passage-prohibited area, information indicating the location of the passage-prohibited area, information of the set period, information of the setting reason, and identification information (for example, name, ID number, and so forth) of the user who set the passage-prohibited area. The identification information of a passage-prohibited area is information for distinguishing the passage-prohibited area from other passage-prohibited areas. The information indicating the location of the passage-prohibited area is, for example, information on the grid cells G that constitute the passage-prohibited area.

When a passage-prohibited area is set, the passage-prohibited area NA is displayed on the track screen 100 in a manner that distinguishes it from other areas. For example, a passage-prohibited area is displayed in a color different from other areas. For example, when the cursor is placed over a passage-prohibited area, the information of the set period and the information of the setting reason associated with the passage-prohibited area is displayed.

When a first-level passage-prohibited area is selected by the user and the closure-cancellation restriction button 410 is operated, the passage prohibition canceler 31 cancels the selected first-level passage-prohibited area, regardless of whether or not the operator administrator has granted approval. On the other hand, when the operator selects a cancellation target second-level passage-prohibited area and operates the closure-cancellation restriction button 410, the passage prohibition canceler 31 cancels the selected second-level passage-prohibited area, on condition that the operator administrator has granted approval.

A setting process performed where there is a restriction on setting a passage-prohibited area will be described. Where there is a restriction on setting a passage-prohibited area, when the first user (for example, operator) performs the setting operation for a passage-prohibited area, the passage prohibition setter 30 confirms whether or not the second user (for example, operator administrator), different from the first user, has approved the setting of the passage-prohibited area. The setting operation for a passage-prohibited area refers, for example, to a pressing operation performed on the route-closure setting button 300 by the operator, with a specific area being selected. For example, where there is a restriction on setting a passage-prohibited area, when the route-closure setting button 300 is operated, with the specific area being selected by the operator, the passage prohibition setter 30 notifies the administrator's terminal 4 of an approval request for setting the specific area as a passage-prohibited area (setting a passage-prohibited area). The operator administrator uses the administrator's terminal 4 to approve the setting of the passage-prohibited area.

For example, when the administrator's terminal 4 receives an approval request for setting a passage-prohibited area from the controller 5, the administrator's terminal 4 presents a notification of the approval request on the display screen 4a. The operator administrator confirms the contents of the approval request for setting the passage-prohibited area on the display screen 4a, and, if approving the approval request, performs an operation of approving the approval request on the administrator's terminal 4. When the operation of approving the approval request for setting a passage-prohibited area is performed, the administrator's terminal 4 transmits an approval notification to the controller 5. If denying the approval request for setting a passage-prohibited area, the operator administrator performs an operation of denying the approval request on the administrator's terminal 4. When the operation of denying the approval request for setting a passage-prohibited area is performed, the administrator's terminal 4 transmits an approval denial notification to the controller 5. If the approval request for setting the specific area selected by the operator as a passage-prohibited area is approved, that is, if an approval notification is received, the passage prohibition setter 30 sets the specific area as a passage-prohibited area.

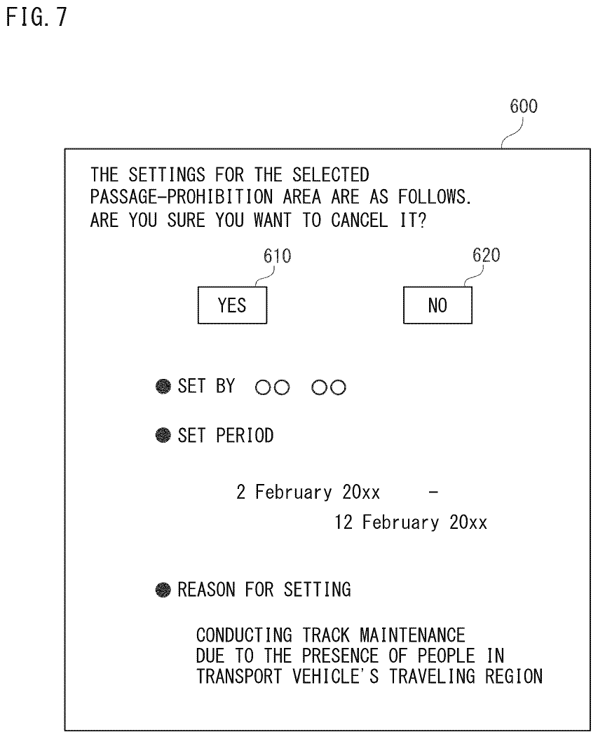

A method for canceling a second-level passage-prohibited area will be described below. When a second-level passage-prohibited area is selected through the inputter 22 and the route-closure closure cancellation button 310 is pressed by the operator, the passage prohibition canceler 31 displays a first confirmation screen 600 on the display screen of the display 23. The first confirmation screen 600 is a screen for confirming the first user's intent to cancel passage prohibition. FIG. 7 is a diagram showing an example of the first confirmation screen 600. The first confirmation screen 600 displays confirmation information including the identification information of the user (for example, the operator administrator) who performed the setting operation for the cancellation target passage-prohibited area, and the setting reason and set period of the passage-prohibited area. The first confirmation screen 600 also displays a message confirming the intent to cancel passage prohibition (hereinafter referred to as the “first confirmation message”), such as “The settings for the selected passage-prohibited area are as follows. Are you sure you want to cancel it?”.

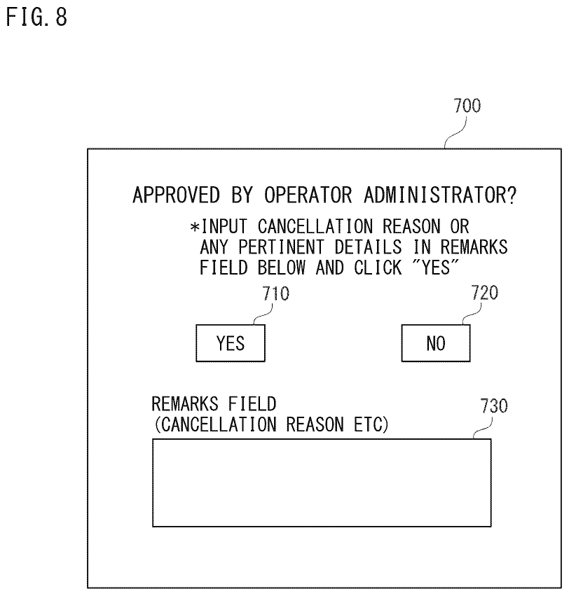

The first confirmation screen 600 also displays a “Yes” button 610 and a “No” button 620. After confirming the confirmation message and confirmation information, the first user presses the “Yes” button 610 in canceling the passage-prohibited area. When the “Yes” button 610 is pressed, a second confirmation screen 700 exemplified in FIG. 8 is displayed on the display 23. After confirming the confirmation message and confirmation information, the first user presses the “No” button 620 in not canceling the passage-prohibited area. When the “No” button 620 is pressed, the passage prohibition canceler 31 calls off the cancellation of the passage-prohibited area. As described above, when the cancellation operation is performed, the passage prohibition canceler 31 displays the confirmation information on the display and executes a first confirmation process in which the first user's intent to cancel the passage prohibition is confirmed.

FIG. 8 is a diagram showing an example of the second confirmation screen 700. The second confirmation screen 700 is a screen for confirming whether the second user has approved the cancellation of the passage prohibition. The second confirmation screen 700 displays a message (hereinafter referred to as “second confirmation message”), such as “Approved by the operator administrator?”, to confirm whether the operator administrator has approved the cancellation of the passage-prohibited area. On the second confirmation screen 700, an input field for inputting a comment is provided. This comment may include, for example, reason for cancellation and pertinent details. Upon confirming the second confirmation message, the first user presses the “Yes” button 710 if the second user (for example, operator administrator) has granted approval. When pressing the “Yes” button 710, the first user may also input a reason for the cancellation in a remarks field 730. Upon confirming the second confirmation message, the first user presses a “No” button 720 if the operator administrator has not granted approval.

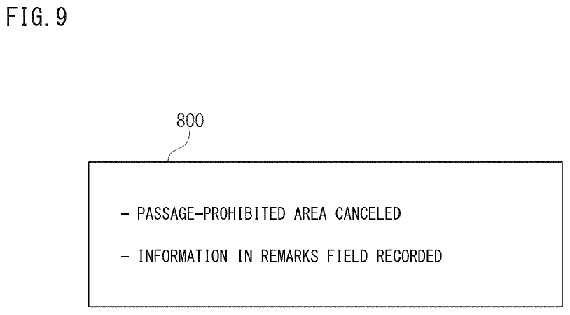

When the “Yes” button 710 is operated, the passage prohibition canceler 31 cancels the cancellation target passage-prohibited area. For example, when the “Yes” button 710 is operated, the passage prohibition setter 30 causes the memory storage 20 to record, as log information in association with each other, information indicating that the cancellation target has been canceled, information on the cancellation reason, and identification information (for example, name, ID number, and so forth) of the user who canceled the cancellation target. For example, when the passage prohibition canceler 31 cancels the cancellation target passage-prohibited area and records the log information in the memory storage 20, as shown in FIG. 9, a screen 800 displaying a message indicating that the passage-prohibited area has been canceled and that the log information has been recorded (hereinafter referred to as “message screen”) is displayed on the display 23.

When the “No” button 720 is operated, the passage prohibition canceler 31 displays a message prompting the acquisition of approval from the operator administrator, such as “Please acquire approval from the operator administrator.”, and suspends or stops the cancellation of the passage-prohibited area. In this manner, the passage prohibition canceler 31, after the first confirmation process, executes the second confirmation process to confirm whether the second user, different from the first user, has approved the cancellation of the passage prohibition. The processing that includes the first confirmation process and the second confirmation process is referred to as specific processing.

For example, in the method for canceling a first-level passage-prohibited area, only the first confirmation process is executed without executing the second confirmation process. In other words, when a first-level passage-prohibited area is selected and the route-closure closure cancellation button 310 is pressed, the passage prohibition canceler 31 displays the first confirmation screen 600 on the display screen of the display 23. When the “Yes” button 610 is pressed, the passage prohibition canceler 31 cancels the cancellation target passage-prohibited area without displaying the second confirmation screen 700. On the first confirmation screen 600, an input field for inputting a reason for cancellation may be provided.

When a passage-prohibited area is canceled by the passage prohibition canceler 31, the notifier 32 notifies all users (including the first user and the second user) registered in the controller 5 that the passage-prohibited area is canceled. For example, when a passage-prohibited area is canceled by the passage prohibition canceler 31, the notifier 32 transmits, via the communicator 21, notification information to all information terminals registered as notification destinations, the notification information including, for example, the identification information of the canceled passage-prohibited area, notification indicating that the passage-prohibited area has been canceled, and the identification information (for example, name) of the user who performed the cancellation. However, this disclosure is not limited to this example, and the notifier 32 may issue the notification information only to the terminal used by the operator administrator, namely, the administrator's terminal 4. The notification from the notifier 32 may be provided via an email, a pop-up notification, or a notification using a social networking service.

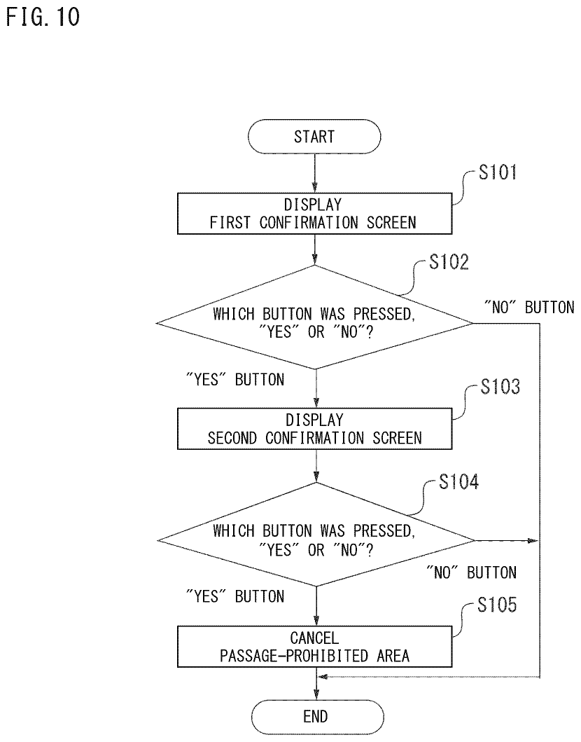

The flow of the process in which a second-level passage-prohibited area is canceled will be described below, with reference to FIG. 10. FIG. 10 is a flowchart of the process in which a second-level passage-prohibited area is canceled. On the management screen CP, the operator selects a cancellation target passage-prohibited area and performs the cancellation operation. Where the cancellation operation for a passage-prohibited area is performed by the operator, the passage prohibition canceler 31 displays the first confirmation screen 600 on the display 23 (Step S101). Where the cancellation operation is performed refers, for example, to when the route-closure closure cancellation button 310 is pressed, with a second-level passage-prohibited area being selected by the operator. However, our method is not limited to this example, and when information indicating the cancellation of a cancellation target passage-prohibited area is received from the information terminal used by the operator, it is also considered where the cancellation operation for the prohibited area is performed.

If the “Yes” button 610 is detected as being pressed on the first confirmation screen 600 (Step S102: “YES” BUTTON), the passage prohibition canceler 31 displays the second confirmation screen 700 on the display 23 (Step S103). On the other hand, if the “No” button 620 is detected as being pressed on the first confirmation screen 600 (Step S102: “NO” BUTTON), the passage prohibition canceler 31 ends the process in which the passage-prohibited area is canceled.

If the “Yes” button 710 is detected as being pressed on the second confirmation screen 700 (Step S104: “YES” BUTTON), the passage prohibition canceler 31 cancels the cancellation target passage-prohibited area, as the operator administrator has approved the cancellation of the passage-prohibited area (Step S105). At this time, upon canceling the passage-prohibited area, the passage prohibition canceler 31 records the information input in the remarks field 730 into the memory storage 20 and displays the message screen on the display 23. On the other hand, if the “No” button 720 is detected as being pressed on the second confirmation screen 700 (Step S104: “NO” BUTTON), the passage prohibition canceler 31 displays on the display 23 a message prompting the acquisition of approval from the operator administrator and suspends or ends the process in which the passage-prohibited area is canceled.

As an example of the second confirmation process, an instance has been described in which the second confirmation screen 700 is displayed to confirm with the first user whether the second user has approved the cancellation of the passage prohibition canceler. However, this disclosure is not limited to this example, and as the second confirmation process, the passage prohibition canceler 31 may request approval from the second user for the cancellation of the passage prohibition. For example, as the second confirmation process, the passage prohibition canceler 31 may transmit to the administrator's terminal 4 information that confirms whether the operator administrator has approved the cancellation of the passage prohibition (the approval request mentioned above). If information indicating approval (the approval notification mentioned above) is received from the administrator's terminal 4, the passage prohibition canceler 31 may cancel the passage-prohibited area.

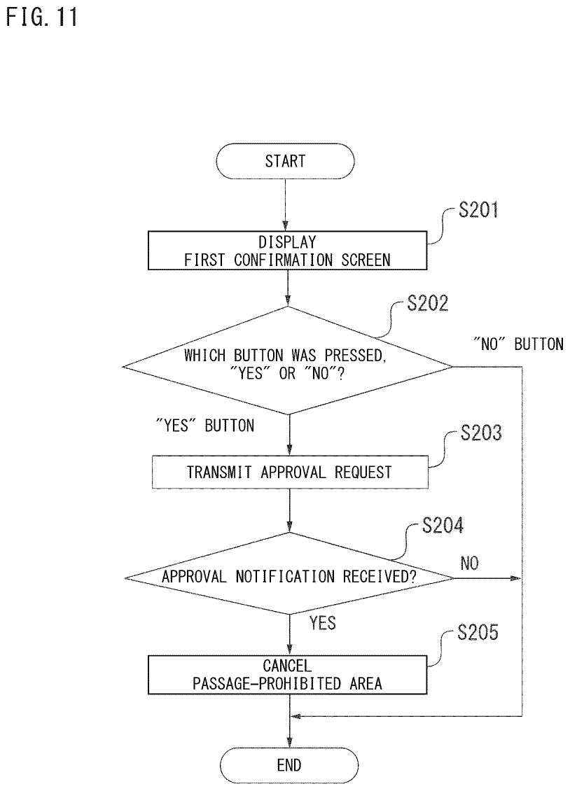

The flow of the cancellation process in performing an approval request as the second confirmation process will be described below, with reference to FIG. 11. FIG. 11 is a flowchart of the cancellation process in performing an approval request as the second confirmation process. Step S201 and Step S202 are the same as Step S101 and Step S102, and therefore, the descriptions thereof will be omitted.

If the “Yes” button 610 is detected as being pressed on the first confirmation screen 600 (Step S202: “Yes” button), the passage prohibition canceler 31 transmits an approval request to the administrator's terminal 4 (Step S203). On the other hand, if the “No” button 620 is detected as being pressed on the first confirmation screen 600 (Step S202: “No” button), the passage prohibition canceler 31 ends the process in which the passage-prohibited area is canceled.

When the operator administrator performs the operation of granting approval, the administrator's terminal 4 transmits an approval notification to the passage prohibition canceler 31. If an approval notification is received from the administrator's terminal 4 (Step S204: YES), the passage prohibition canceler 31 cancels the cancellation target passage-prohibited area, as the operator administrator has approved the cancellation of the passage-prohibited area (Step S205). On the other hand, if an approval denial notification is received from the administrator's terminal 4 (Step S204: NO), the passage prohibition canceler 31 ends the process in which the passage-prohibited area is canceled as the approval is not granted. When an approval denial notification is received from the administrator's terminal 4, the passage prohibition canceler 31 may display a message on the display 23 indicating that the operator administrator has not granted approval.

In the above description, the necessity of the operator administrator's approval has been described as an example of a restriction on setting a passage-prohibited area, however, this disclosure is not limited to this example. For example, a restriction on setting a passage-prohibited area may also mean that a passage-prohibited area cannot be set regardless of whether or not the operator administrator grants approval. In the above description, the necessity of the operator administrator's approval has been described as an example of a restriction on canceling a passage-prohibited area, however, this disclosure is not limited to this example. For example, a restriction on canceling a passage-prohibited area may also mean that a passage-prohibited area cannot be canceled regardless of whether or not the operator administrator grants approval.

The setting of a passage-prohibited area is restricted only when the operator sets the passage-prohibited area. Therefore, when the operator administrator sets a passage-prohibited area, the setting of the passage-prohibited area is not restricted. Similarly, when the operator administrator cancels a passage-prohibited area, there is no restriction on canceling the passage-prohibited area. The passage prohibition setter 30 may, for example, identify, based on the logged-in user's authorization information, whether the user who performed a setting operation for a passage-prohibited area (for example, pressing the route-closure setting button 300) or a cancellation operation for a passage-prohibited area (for example, pressing the route-closure cancellation button 310) is an operator or an operator administrator. The operator administrator may use the administrator's terminal 4 to log into the controller 5 and perform a setting operation for a passage-prohibited area or a cancellation operation for a passage-prohibited area.

As described above, the controller 5 executes, where the first user performs a cancellation operation for a passage-prohibited area, specific processing including a process of confirming whether the second user has approved the cancellation of the passage-prohibited area. The controller 5 cancels the passage prohibition if the second user has approved the cancellation of the passage prohibition. With such a configuration, the controller 5 can suppress passage prohibition from being canceled due to operational mistakes of the user.

The traveling vehicle system 1 may also include a mechanical stopper. In the traveling vehicle system 1, it is possible to suppress passage prohibition from being canceled due to operational mistakes of the user, and it is thus possible to suppress the traveling vehicle from coming into contact with the mechanical stopper due to the cancellation of a passage-prohibited area caused by operational mistakes.

The second user is not limited to being an operator administrator and may be, for example, multiple operators. In other words, the approval required in the second confirmation process is not limited to an operator administrator's approval and may also be approvals from multiple individuals. The second user only needs to be different from the first user and may be a different operator.

Our controller, system and method disclose the following configurations.

### Configuration 1

A controller (5) that controls traveling of a traveling vehicle (3) on a track (2), the controller (5) comprising a passage prohibition setter (30) that sets a predetermined area on the track (2) as a passage-prohibited area, and a passage prohibition canceler (31) that executes, where a first user performs a cancellation operation for the passage-prohibited area, specific processing including a process of confirming whether a second user, different from the first user, has approved cancellation of the passage-prohibited area, wherein the passage prohibition canceler (31) cancels the passage-prohibited area where it is confirmed that the second user has approved cancellation of the passage-prohibited area.

### Configuration 2

The controller (5) according to configuration 1, wherein the passage prohibition setter (30) sets the predetermined area as the passage-prohibited area where the second user performs a setting operation that instructs to set the passage-prohibited area, and sets the predetermined area as the passage-prohibited area on condition that the second user has approved the setting of the passage-prohibited area, where the first user performs the setting operation.

### Configuration 3

The controller (5) according to configuration 1 or 2, wherein, in setting the predetermined area as the passage-prohibited area, the passage prohibition setter (30) displays on a display (23) an input screen having an input field to input a reason for setting the passage-prohibited area, and stores in a memory storage (20) information input into the input field and information indicating the passage-prohibited area in association with each other.

### Configuration 4

The controller (5) according to any one of configurations 1 to 3, wherein the specific processing includes a first confirmation process in which, where the cancellation operation is performed, the first user's intent to cancel the passage-prohibited area is confirmed by displaying on a display (23) identification information of the second user who performed a setting operation for the passage-prohibited area and a setting reason for the passage-prohibited area, and a second confirmation process in which, where the first user's cancellation intent is confirmed in the first confirmation process, whether the second user has approved the cancellation of the passage-prohibited area is confirmed.

### Configuration 5

The controller (5) according to configuration 5, wherein the passage prohibition canceler (31), as the second confirmation process, displays on the display (23) a confirmation screen to confirm whether the second user has approved the cancellation of the passage-prohibited area, and cancels the passage-prohibited area where a predetermined operation is performed on the confirmation screen.

### Configuration 6

The controller (5) according to configuration 5, wherein the passage prohibition canceler (31), as the second confirmation process, transmits to an information terminal (4) used by the second user a request to the second user to approve cancellation of the passage-prohibited area, and cancels the passage-prohibited area where information indicating approval is received from the information terminal (4).

### Configuration 7

The controller (5) according to any one of configurations 1 to 6, wherein the passage-prohibited area can be set to either a first level or a second level, and wherein the passage prohibition canceler (31) executes the specific processing when canceling the passage-prohibited area set to the second level, and, without executing the specific processing, cancels the passage prohibition of the predetermined area set to the first level based on the cancellation operation by the first user when canceling the passage-prohibited area set to the first level.

### Configuration 8

The controller (5) according to any one of configurations 1 to 7, further comprising a notifier (32) that notifies all users, including the first user and the second user registered in the controller (5), where the passage-prohibited area is canceled.

### Configuration 9

The controller (5) according to any one of configurations 1 to 8, wherein the first user performs a setting operation for the passage-prohibited area, the passage prohibition setter (30) confirms whether a second user, different from the first user, has approved the setting of the passage-prohibited area, and sets the passage-prohibited area where it is confirmed that the second user has approved the setting of the passage-prohibited area.

The example has been described above. However, the technical scope of is not limited to the description of the above example. It is also apparent to those skilled in the art that various modifications or improvements can be added to the above example. It is also apparent from the scope of claims that this disclosure also encompasses one or more of such modifications or improvements. One or more of the requirements described may be omitted in some instances. One or more of the requirements described may be combined where appropriate. The order of executing procedures shown can be implemented in an arbitrary order unless the result of the previous procedure is used in the following procedure. While operations have been described with expressions such as “first”, “next”, and “subsequently” for the sake of convenience, the operations need not always be implemented in that order. The contents of Japanese Patent Application No. 2022-172265 and all documents cited in the detailed description are incorporated herein by reference to the extent permitted by law.

1. A controller that controls traveling of a traveling vehicle on a track, the controller comprising
a passage prohibition setter that sets a predetermined area on the track as a passage-prohibited area, and
a passage prohibition canceler that executes, where a first user performs a cancellation operation for the passage-prohibited area, specific processing including a process of confirming whether a second user, different from the first user, has approved cancellation of the passage-prohibited area,
wherein the passage prohibition canceler cancels the passage-prohibited area where it is confirmed that the second user has approved cancellation of the passage-prohibited area.

2. The controller according to claim 1,
wherein the passage prohibition setter sets the predetermined area as the passage-prohibited area where the second user performs a setting operation that instructs to set the passage-prohibited area.

3. The controller according to claim 2,
wherein the passage prohibition setter sets the predetermined area as the passage-prohibited area on condition that the second user has approved the setting of the passage-prohibited area, where the first user performs the setting operation.

4. The controller according to claim 1,
wherein, in setting the predetermined area as the passage-prohibited area, the passage prohibition setter displays on a display an input screen having an input field to input a reason for setting the passage-prohibited area, and stores in a memory storage information input into the input field and information indicating the passage-prohibited area in association with each other.

5. The controller according to claim 1,
wherein the specific processing includes
a first confirmation process in which, where the cancellation operation is performed, the first user's intent to cancel the passage-prohibited area is confirmed by displaying on a display identification information of the second user who performed a setting operation for the passage-prohibited area and a setting reason for the passage-prohibited area, and
a second confirmation process in which, where the first user's cancellation intent is confirmed in the first confirmation process, whether the second user has approved the cancellation of the passage-prohibited area is confirmed.

6. The controller according to claim 5,
wherein the passage prohibition canceler, as the second confirmation process, displays on the display a confirmation screen to confirm whether the second user has approved the cancellation of the passage-prohibited area, and cancels the passage-prohibited area where a predetermined operation is performed on the confirmation screen.

7. The controller according to claim 5,
wherein the passage prohibition canceler, as the second confirmation process, transmits to an information terminal used by the second user a request to the second user to approve cancellation of the passage-prohibited area, and cancels the passage-prohibited area where information indicating approval is received from the information terminal.

8. The controller according to claim 1,
wherein the passage-prohibited area can be set to either a first level or a second level, and
wherein the passage prohibition canceler executes the specific processing when canceling the passage-prohibited area set to the second level, and, without executing the specific processing, cancels the passage prohibition of the predetermined area set to the first level based on the cancellation operation by the first user when canceling the passage-prohibited area set to the first level.

9. The controller according to claim 1, further comprising
a notifier that notifies all users, including the first user and the second user registered in the controller, where the passage-prohibited area is canceled.

10. The controller according to claim 1,
wherein the first user performs a setting operation for the passage-prohibited area, the passage prohibition setter confirms whether a second user, different from the first user, has approved the setting of the passage-prohibited area, and sets the passage-prohibited area where it is confirmed that the second user has approved the setting of the passage-prohibited area.

11. A traveling vehicle system comprising
a traveling vehicle,
a track on which the traveling vehicle travels, and
the controller according to claim 1 that controls the traveling vehicle that travels along the track.

12. A cancellation method for canceling a passage-prohibited area in a predetermined area on a track on which a traveling vehicle travels, the cancellation method comprising
executing, where a first user performs a cancellation operation for the passage-prohibited area, specific processing including a process of confirming whether a second user, different from the first user, has approved cancellation of the passage-prohibited area, and
canceling the passage-prohibited area where it is confirmed that the second user has approved cancellation of the passage-prohibited area.
